(19) United States
(12) Patent Application Publication
(10) Pub. No.: US 2026/0251472 A1
(43) Pub. Date: Aug. 27, 2026

(54) SAFETY MESSAGE AND ADVERTISEMENT TRANSMISSION SYSTEM USING VEHICLE DISPLAY DEVICE

(71) Applicant: UNIICT CO., LTD., Yangju-si, Gyeonggi-do (KR)

(72) Inventor: Jun Sung MA, Yangju-si, Gyeonggi-do (KR)

(73) Assignee: UNIICT CO., LTD., Yangju-si, Gyeonggi-do (KR)

(21) Appl. No.: 19/471,607

(22) PCT Filed: Sep. 19, 2023
(86) PCT No.: PCT/KR2023/014158

§ 371 Date: Oct. 1, 2025

(30) Foreign Application Priority Data
Sep. 18, 2023 (KR) 10-2023-0123814

(51) Int. Cl. G01C 21/36; B60Q 1/50; G06F 3/14; G06Q 30/0251

(52) U.S. Cl. CPC G01C 21/3697; B60Q 1/5035; G06F 3/14; G06Q 30/0266

(57) ABSTRACT

A safety message and advertisement transmission system includes a vehicle display device and a commercial server. The vehicle display device includes: a display unit disposed facing behind a vehicle; an operation unit that receives, from a user, a selection of a message to be displayed on the display unit; and a control unit that transmits the selected message from the operation unit to the display unit. The commercial service provides commercial information to the vehicle display device.

### CROSS-REFERENCE TO PRIOR APPLICATIONS

This Application is a National Stage Patent Application of PCT International Application No. PCT/KR2023/014158 (filed on Sep. 19, 2023), which claims priority to Korean Patent Application No. 10-2023-0123814 (filed on Sep. 18, 2023), which are all hereby incorporated by reference in their entirety.

### BACKGROUND

The present disclosure relates to a safety message and advertisement transmission system using a vehicle display device and, more particularly, to a system for transmitting safety messages and advertisements by using a display device installed toward the rear of a vehicle and configured to transmit the messages to other vehicles.

Recently, traffic disputes between drivers have been increasing. In situations, such as cutting in, stopping suddenly, or braking suddenly, where communication between the drivers is required, simple flashing lights and left/right turn signals alone are not enough to accurately convey the intentions of the drivers. For resolving such a problem, attempts to display a driver's messages through a display installed in a vehicle are becoming more diverse.

In addition, in the automotive signage industry, advertising using displays is being implemented by utilizing various regulatory exemption systems.

For example, a display is installed inside and outside of an automobile so as to display advertisements or safety messages appropriate to driving situations.

However, when a driver takes action to display a specific message while driving, this kind of action may cause an accident due to careless driving, and may also cause a disturbance to surrounding vehicles due to the glare of the display.

Therefore, there is a need for control technology and methods capable of safely transmitting messages or advertisements using the display of such an automobile.

### SUMMARY

An objective of the present disclosure is to provide a system for transmitting safety messages and advertisements by using a display device installed toward the rear of a vehicle and configured to transmit the messages to other vehicles.

According to one feature for realizing the objective of the present disclosure described above, there is provided a system for transmitting safety messages and advertisements by using a display device installed toward the rear of a vehicle and configured to transmit the messages to other vehicles, the system including: the vehicle display device including a display unit arranged toward a rear of a vehicle, an operation unit for receiving a message to be displayed on the display unit from a user, and a control unit for transmitting the message selected from the operation unit to the display unit; and a commercial server for providing commercial information to the vehicle display device.

In this case, the system may further include a mobile terminal for establishing a connection so as to display the commercial information provided by the commercial server on the vehicle display device.

In addition, the commercial server may include: an information collection unit configured to receive driving information of the vehicle from the mobile terminal; an advertisement provision unit configured to determine the commercial information to be displayed on the display device on the basis of the information collected by the information collection unit; and a profit management unit configured to bill a provider who provides the corresponding commercial information and settle a profit with the user of the vehicle display device, which displays the commercial information, on the basis of whether the commercial information is displayed.

Meanwhile, the information collection unit may be configured to receive a driving route of the vehicle and a current driving state of the vehicle by linking with a driving route guidance application running on the mobile terminal, and the advertisement provision unit may be configured to select and provide an advertisement message provided by an advertisement provider on the basis of the current driving state and the driving route of the vehicle.

Meanwhile, the profit management unit may be configured to provide a portion of advertising profits to a driver of the vehicle on the basis of a display location and display count of the provided message.

According to the system for transmitting safety messages and advertisements by using a display device according to the present disclosure, the effects are as follows:

Firstly, the system may contribute to improving traffic flow and safe driving by conveying a driver's driving intention through a display panel equipped at the rear of a vehicle.

Secondly, having a transparent form, the display panel does not obstruct the driver's rear view even when the display panel is equipped on a rear window of the vehicle.

Thirdly, the system does not hinder safe driving because the system is able to transmit desired messages through simple operation.

Lastly, an implementer of the present disclosure may obtain additional profits through the provision of commercial information in addition to profits from the sale of vehicle display devices.

### BRIEF DESCRIPTION OF THE DRAWINGS

FIG. 1 is a view illustrating a conventional display device.

FIG. 2 is a block diagram illustrating a vehicle display device for implementing one exemplary embodiment of the present disclosure.

FIG. 3 is a view illustrating a first button module according to one exemplary embodiment.

FIG. 4 is a view illustrating a second button module according to one exemplary embodiment.

FIG. 5 is a view illustrating a display unit according to one exemplary embodiment.

FIG. 6 a view illustrating a first button module according to another exemplary embodiment.

FIG. 7 is a view illustrating a first button module according to a yet another exemplary embodiment.

FIG. 8 is a block diagram illustrating a safety message and advertisement transmission system using a vehicle display device according to the present disclosure.

### DETAILED DESCRIPTION

Hereinafter, preferred exemplary embodiments of the present disclosure will be described in more detail with reference to the attached drawings. At this time, it should be noted that in the attached drawings, identical components are indicated by identical symbols whenever possible. In addition, detailed descriptions of known functions and configurations that may obscure the gist of the present disclosure will be omitted. For the same reason, some components in the attached drawings are exaggerated, omitted, or schematically illustrated.

Before describing a safety message and advertisement transmission system using a vehicle display device according to the present disclosure, the vehicle display device 1000 will be described in detail.

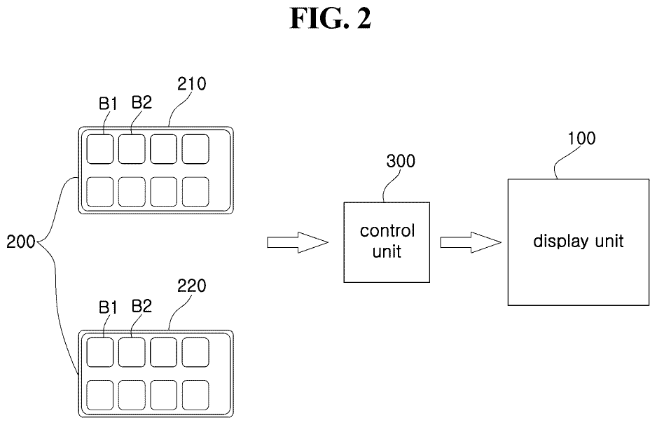

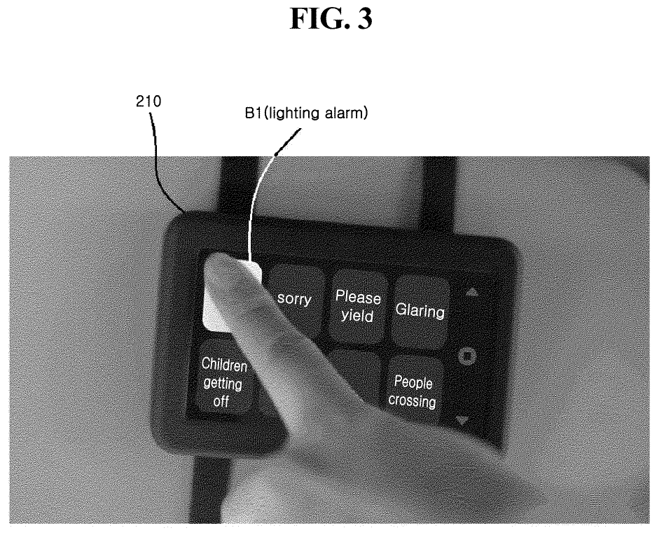

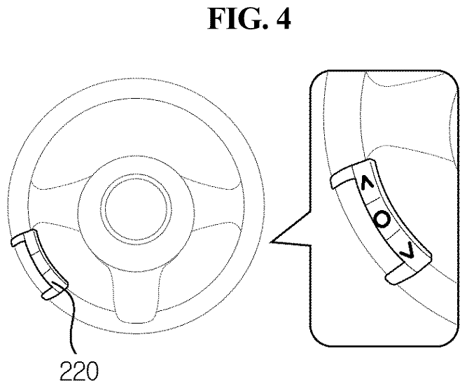

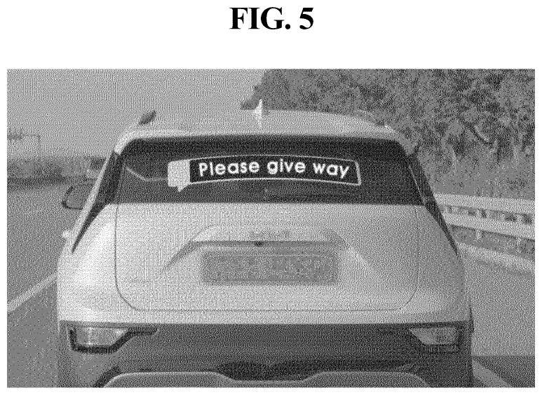

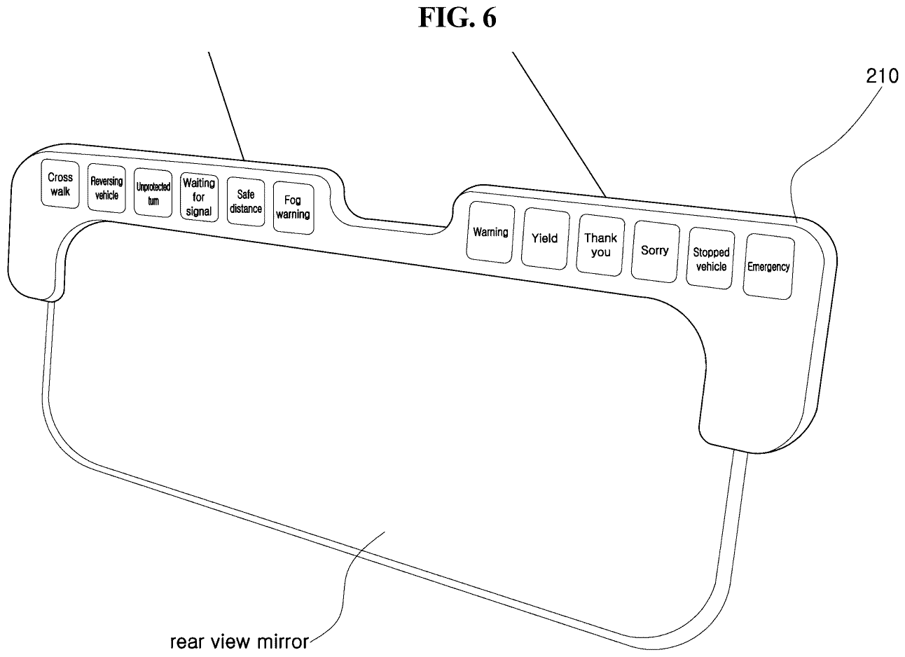

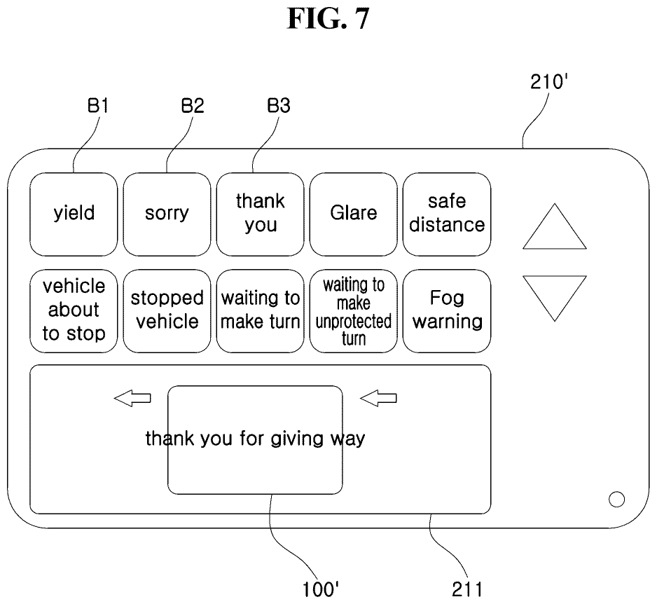

FIG. 2 is a block diagram illustrating a vehicle display device for implementing one exemplary embodiment of the present disclosure. FIG. 3 is a view illustrating a first button module according to one exemplary embodiment. FIG. 4 is a view illustrating a second button module according to one exemplary embodiment. FIG. 5 is a view illustrating a display unit according to one exemplary embodiment. FIG. 6 a view illustrating a first button module according to another exemplary embodiment. FIG. 7 is a view illustrating a first button module according to a yet another exemplary embodiment.

Referring to FIGS. 2 to 7, the vehicle display device 1000 for implementing the present disclosure includes a display unit 100, an operation unit 200, and a control unit 300.

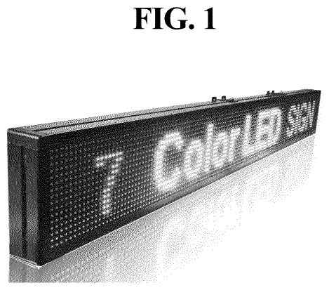

The display unit 100 is a component arranged to face the rear of a vehicle and is preferably provided on a transparent substrate. The display unit 100 includes a plurality of light-emitting elements forming an M×N array. However, depending on implementation conditions, it is also possible to implement the display unit 100 by using a general LED panel such as that shown in FIG. 1. For example, when applied to cargo vehicles, etc., since the transparent panel may not have an advantage, the display unit 100 may also be implemented with a conventional LED panel for reasons such as reducing manufacturing costs and enhancing durability.

The display unit 100 includes a control data input port and is controlled for the operation of the light-emitting elements arranged in series. At this time, the M×N array may be realized as a 16×64 array, a 256×512 array, or the like for visibility. A message is displayed in text format through the display unit 100.

Although not shown, the display unit 100 may measure external illuminance through an ambient light sensor equipped in the display unit or an ambient light sensor equipped in the vehicle. A display with a brightness of 10 cd/m² to 2,000 cd/m² depending on the external illuminance may be selectively implemented.

At this time, as a single sensor or a surface receiving sensor, the ambient light sensor receives light, and the display unit 100 may adjust the brightness as required to a specified brightness according to the received external illuminance.

The brightness of the display unit 100 is adjusted according to the surrounding brightness, so that visibility may be improved. In particular, when the vehicle enters a tunnel, the brightness of the display unit 100 may be immediately lowered, so that any obstruction to the view of a driver of a vehicle following behind may be maximally reduced.

The operation unit 200 receives a message to be displayed on the display unit 100 from a user.

The message to be displayed on the display unit 100 is about a situation that occurs while driving, and examples thereof include “Yield,” “Thank you,” “Glare,” “Safe distance,” “Sorry,” “Vehicle about to stop,” “Stopped vehicle,” and the like.

For example, when changing lanes, “Yield” can be used when a driver requests that other vehicles behind him/her, traveling in the lane the driver intend to change into, maintain a safe distance. “Thank you” may be used when the vehicle behind slows down to provide the safe distance when making the lane change.

A message may be displayed as a single word, or as a short sentence consisting of several words. In addition, the message may be customized by the user.

The operation unit 200 is a physical interface that receives the input of a user's operation, and the operation unit 200 is implemented in a form provided with buttons that allow the user to select a message that he or she desires to display on the display unit 100, such as “Yield,” “Thank you,” “Glare,” “Safe distance,” “Vehicle about to stop,” and “Stopped vehicle”.

Depending on the embodiments, each “Button” may be a physical button or may also be implemented as one using a touch screen.

The control unit 300 transmits a message selected from the operation unit 200 to the display unit 100. The control unit 300 includes a driver circuit for electrically driving the display unit 100 and may further include a logic module that drives software for customizing message content as required. In addition, the control unit 300 may further include a communication module for establishing a connection with a user's smartphone.

The operation unit 200 may be implemented in a form mounted on a dashboard or sun visor of a vehicle, or may also be implemented in a form mounted on a steering wheel. Alternatively, it is also possible to implement the operation unit 200 in a form mounted on a rear view mirror as shown in FIG. 6.

In the present embodiment, the operation unit 200 includes: a first button module 210 in a form mounted on a dashboard or sun visor of a vehicle for convenience of operation and safety of driving; and a second button module 220 in a form mounted on a steering wheel. It is possible to implement the operation unit 200 using only one of the first button module 210 and the second button module 220, but it is preferable to have both modules for safe operation.

The first button module 210 is provided with a plurality of message transmission buttons B1, B2, . . . , etc. corresponding to respective messages.

When each message transmission button is implemented in the form of a physical button, the first button module 210 has the number of buttons respectively corresponding to the number of messages. As in the example shown, the number of message transmission buttons B1, B2, . . . , etc. may be implemented with the number thereof ranging from 1 to 30.

Each message transmission button B1, B2,. etc. displays a message to be displayed on the display unit 100. For a physical button, a “message” is provided in a form printed on a surface of the physical button.

When user selects (i.e., presses) a specific message transmission button (e.g., “Yield”), a message corresponding to the relevant button is displayed on the display unit 100.

The content corresponding to a “Yield” button may be “Please give way”, “Please let me in”, etc.

The second button module 220 has the simplified number of message transmission buttons so as to be mounted on a steering wheel, but a fundamental operation method may be implemented in the same manner as that of the first button module 210.

Meanwhile, selection of the message transmission button Bl, B2, . . . , etc. may be done by voice recognition as well as by direct operation with a user's hand.

Up to here, this is the description of the fundamental embodiments of the operation unit 200, and from below, an automatic message selection function for safe driving will be described.

The method in which a user directly selects and presses the buttons of the first button module 210 or the second button module 220 is an intuitive operable method, but in some cases, this method may distract the user's attention.

In the present embodiment, the operation unit 200 may execute an alarming function in a way of lighting a message transmission button corresponding to a current driving state of a vehicle in conjunction with the driving states of the vehicle.

For example, the operation unit 200 may detect a change in acceleration of the vehicle and display a light on a message transmission button corresponding to “Sorry” when a sudden stop occurs.

The user may quickly and visually identify the button with light on, thereby maximally reducing driver distraction.

As another example, the operation unit 200 may display a light on a message transmission button corresponding to “Vehicle about to stop” when arriving at a destination by linking with a navigation and vehicle information system (an audio video navigation (AVN) system). As a yet another example, when a user operates a turn signal (i.e., a direction indicator light), the operation unit 200 may display a light on a message transmission button corresponding to a message of “Vehicle about to stop”.

Depending on the embodiments, the operation unit 200 may be directly interfaced with each of vehicle devices. It is also possible to implement that the control unit 300 performs the operation related to interfaces and the operation unit 200 only performs control to light a specific button according to an interface result.

It is possible to randomly select a plurality of message transmission buttons at the same time as well as to select just one message transmission button.

For example, when two messages, “Stopped vehicle” and “Sorry,” are selected, the corresponding messages may be displayed alternately on the display unit 100 for a set period of time.

In addition, when a certain message is being transmitted to the display unit 100, if a different message transmission button is pressed, the existing message may be controlled to be terminated and another message selected this time may be output, and depending on the settings, the existing message as well as another message selected this time may be transmitted alternately at the same time.

The control unit 300 may include an AI learning unit (not shown). For example, the AI learning unit may be trained on cases that a user actually presses lit message transmission buttons, so that depending on a learning progress, the AI learning unit may perform operation of automatically pressing a message transmission button even when the user does not actually press the message transmission button.

The AI learning unit may be implemented within the control unit 300, or may also be implemented on a user's smartphone, which is interfaced with the control unit 300. Trained history may be stored on the user's smartphone, allowing the trained history to be applied as is, even when the user happens to use another vehicle.

In another embodiment, message transmission buttons B1, B2, . . . , etc. may be selected by using a first button module 210 and a second button module 220. The second button module 220 has a form of simplified buttons.

The configuration in which the operation unit 200 performs an alarming function by lighting a message transmission button corresponding to a current driving state of a vehicle in conjunction with the driving states of the vehicle is the same as the configuration of the previous embodiment. That is, the operation unit performs the alarming function by lighting up the message transmission button corresponding to the current driving state of the vehicle in conjunction with the driving states of the vehicle.

When a specific message transmission button of the first button module 210 lights up, a user does not directly operate the first button module 210, but rather operates the second button module 220 mounted on the steering wheel so as to “approve” the transmission of a message corresponding to the relevant message transmission button.

For example, when a vehicle comes to a sudden stop, a message transmission button corresponding to “Sorry” in the first button module 210 lights up, and the user operates an “approval button” provided in the second button module 220, so as to allow the corresponding message to be displayed on the display unit 100.

That is, in the present embodiments, it is easy to understand that the second button module 220 functions as a remote controller.

Although not shown, the second button module 220 may be implemented in a simplified form having three buttons.

The second button module 220 includes: an “approval button” for performing approval of a message transmission button that is lit in the first button module 210; a “left selection button” for changing a selected message transmission button to a button in the left; and a “right selection button” for changing a selected message transmission button to a button in the right.

The user may select a message, which is desired to be transmitted, from the first button module 210 by operating the “right selection button” or the “left selection button” (i.e., selecting a message transmission button corresponding to the relevant message), and subsequently, the user may also select and transmit the message at will by pressing the “approval button”.

Depending on implementers, the second button module 220 may be implemented as an operation button built into a steering wheel of a vehicle through collaboration with a vehicle manufacturer.

FIG. 7 is a view illustrating a first button module according to a yet another exemplary embodiment. The first button module 210′ according to the present embodiment further includes a message display window 211 for actually displaying message content displayed on the display unit 100. The message display window 211 displays the actual messages corresponding to message transmission buttons B1 and B3. The example shows the actual messages that are displayed when both “Yield” and “Thank you” are selected simultaneously.

Meanwhile, in order to let a user to know when the number of characters in a message exceeds the limited number of characters displayable on the display unit 100, an area 100′ corresponding to the resolution of the display unit 100 may be additionally displayed on the message display window 211. According to the present configuration, the user may confirm in advance that a running message will be displayed in a loop in the corresponding area 100′.

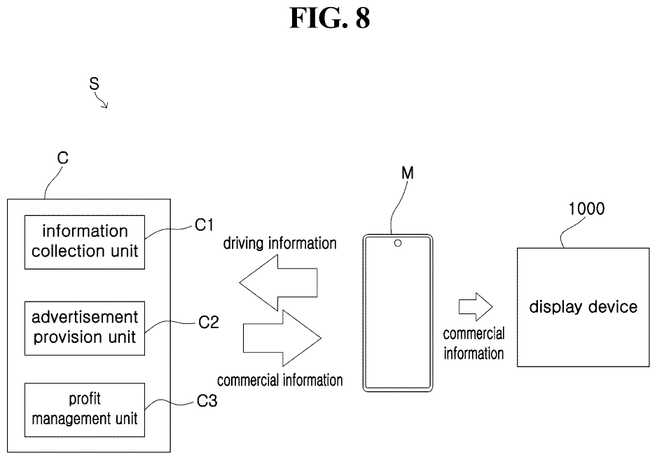

FIG. 8 is a block diagram illustrating the safety message and advertisement transmission system using the vehicle display device according to the present disclosure. The safety message and advertisement transmission system S using the vehicle display device includes a vehicle display device 1000, a commercial server C, and a mobile terminal M.

Since the vehicle display device 1000 may be implemented by using the vehicle display device 1000 described in FIGS. 2 to 7, redundant description will be omitted. For simple implementation, an embodiment in which the operation unit 200 is omitted is also applicable to the safety message and advertisement transmission system S of the present disclosure.

The commercial server C provides commercial information to the vehicle display device 1000. The commercial server C is located in a place such as a data center, and includes both hardware in concept that performs computer processing and software in concept that processes information. Depending on the choices of implementers, the commercial server C may be implemented on physically independent hardware, or may be implemented by using a commercial cloud service.

Meanwhile, commercial information includes, for example, “advertisements,” “local advertisements,” “traffic information,” “weather information,” etc. This example is not limited thereto, and this kind of information provided may be subject to change or addition depending on the partnership with an information service provider.

The mobile terminal M establishes a connection, so as to display the commercial information provided from the commercial server C on the vehicle display device 1000.

The mobile terminal M is a portable computer processing device, having information and communication functions, such as a tablet PC or smartphone. A dedicated application (not shown) for implementing the safety message and advertisement transmission system is installed and operated on the mobile terminal M. For the sake of convenience and understanding, the dedicated application will be referred to as a “message display app.”

Since the vehicle display device 1000 is not provided with a communication function for connecting to the Internet, the vehicle display device 1000 is unable to receive information directly from the commercial server C. Accordingly, the vehicle display device 1000 has a configuration that receives commercial information through the mobile terminal M. However, when a vehicle display device 1000 is implemented by including a remote communication function therein, the mobile terminal M may be omitted.

The commercial server C includes an information collection unit C1, an advertisement provision unit C2, and a profit management unit C3. The information collection unit C1, advertisement provision unit C2, and profit management unit C3 are logically distinguished from each other in order to describe the operation of the commercial server C. The code of programs for actually running the commercial server C may be different from each other.

The information collection unit C1 receives driving information of a vehicle from a mobile terminal M. Here, the “Driving information” includes at least one of the vehicle's route from a starting point to a destination, a current vehicle location, and a current vehicle driving state (i.e., constant speed driving, stopped vehicle, acceleration, deceleration, lane change, etc.). The “Driving information” may be collected through a “message display app” running on the mobile terminal M by using devices such as a GPS module and acceleration sensor module, which are equipped on the mobile terminal M. “The vehicle's route from the starting point to the destination” may be collected by interfacing with a driving route guidance application (e.g., a commercial navigation app) running on the mobile terminal M.

The advertisement provision unit C2 determines commercial information to be displayed on the vehicle display device 1000 on the basis of the information collected by the information collection unit C1.

For example, when a location of a relevant vehicle corresponds to a location where a “local advertisement” in a specific area is requested, the advertisement provision unit C2 transmits a “local advertisement” message corresponding to the corresponding location to the “message display app” running on the mobile terminal M, and the “message display app” controls the received “local advertisement” to be displayed on the vehicle display device 1000.

At this time, the commercial information such as the “local advertisement” is not displayed while driving the vehicle for safety reasons, and is set to be displayed only when the vehicle is stopped or moving slowly that is due to reasons such as waiting at a signal or traffic congestion.

Based on whether or not commercial information is displayed, the profit management unit C3 bills a provider who provided the commercial information and settles profits for the user of the vehicle display device on which the commercial information is displayed. For example, the profit management unit may provide a portion of the advertising profits to a driver of the vehicle on the basis of a display location and display count of the provided message.

Although the present disclosure has been described with reference to the above exemplary embodiments, those skilled in the art will be able to understand that various modifications and changes may be made to the present disclosure without departing from the idea and scope of the present disclosure as set forth in the claims below.

1. A system for transmitting safety messages and advertisements by using a vehicle display device, the system comprising:
the vehicle display device comprising a display unit arranged toward a rear of a vehicle, an operation unit for receiving a message to be displayed on the display unit from a user, and a control unit for transmitting the message selected from the operation unit to the display unit; and
a commercial server for providing commercial information to the vehicle display device.

2. The system of claim 1, further comprising:
a mobile terminal for establishing a connection so as to display the commercial information provided by the commercial server on the vehicle display device.

3. The system of claim 2, wherein the commercial server comprises:
an information collection unit configured to receive driving information of the vehicle from the mobile terminal;
an advertisement provision unit configured to determine the commercial information to be displayed on the display device on the basis of the information collected by the information collection unit; and
a profit management unit configured to bill a provider who provides the corresponding commercial information and settle a profit with the user of the vehicle display device, which displays the commercial information, on the basis of whether the commercial information is displayed.

4. The system of claim 3, wherein the information collection unit is configured to receive a driving route of the vehicle and a current driving state of the vehicle by linking with a driving route guidance application running on the mobile terminal, and
the advertisement provision unit is configured to select and provide an advertisement message provided by an advertisement provider on the basis of the current driving state and the driving route of the vehicle.

5. The system of claim 4, wherein the profit management unit is configured to provide a portion of advertising profits to a driver of the vehicle on the basis of a display location and display count of the provided message.
